(19) United States
(12) Patent Application Publication
(10) Pub. No.: US 2025/0239685 A1
(43) Pub. Date: Jul. 24, 2025

(54) POWER STORAGE DEVICE

(71) Applicant: TOYOTA JIDOSHA KABUSHIKI KAISHA, Toyota-shi (JP)

(72) Inventors: Shintaro UTSUMI, Susono-shi (JP); Takeru HARA, Toyota-shi (JP); Masataka OGUSHI, Nisshin-shi (JP); Yuji NISHI, Nagoya-shi (JP); Naofumi NOMURA, Nagakute-shi (JP); Nariaki MIKI, Okazaki-shi (JP); Kenta KIMURA, Toyota-shi (JP)

(73) Assignee: TOYOTA JIDOSHA KABUSHIKI KAISHA, Toyota-shi (JP)

(21) Appl. No.: 18/968,184

(22) Filed: Dec. 4, 2024

(30) Foreign Application Priority Data
Jan. 24, 2024 (JP) 2024-008790

(51) Int. Cl. H01M 10/6556; H01M 10/613; H01M 10/653; H01M 10/658

(52) U.S. Cl. CPC H01M 10/6556; H01M 10/613; H01M 10/653; H01M 10/658

(57) ABSTRACT

A power storage device includes a power storage module including a plurality of power storage cells, a cooler arranged above the power storage module in a vertical direction, and a thermally conductive layer sandwiched between the power storage module and the cooler. The cooler includes a plurality of flow path portions arranged side by side in an X direction, and a connecting portion that is arranged between the flow path portions arranged side by side in the X direction and connects the flow path portions to each other. The connecting portion has a bending rigidity lower than that of each of the plurality of flow path portions.

### CROSS REFERENCE TO RELATED APPLICATIONS

This nonprovisional application is based on Japanese Patent Application No. 2024-008790 filed on Jan. 24, 2024 with the Japan Patent Office, the entire contents of which are hereby incorporated by reference.

### BACKGROUND

### Field

The present disclosure relates to a power storage device.

### Description of the Background Art

Japanese National Patent Publication No. 2023-529400 discloses a battery pack including a plurality of cells, a tray, a plate, and cooling pipes. The plurality of cells are accommodated in an accommodating space of the tray. The plate covers the top opening of the accommodating space of the tray. The cooling pipes are arranged on the outer surface (the surface opposite to the accommodating space) of the plate.

### SUMMARY

Although not explicitly described in Japanese National Patent Publication No. 2023-529400 above, in some cases, a thermally conductive layer is arranged between the plate (cooler) and the plurality of cells (power storage cells). In other cases, there may be variations in height among the plurality of cells. In such cases, a cell having a relatively small height needs a relatively thick thermally conductive layer to be arranged (stacked) thereon to conform to the flat shape of the plate. This results in a decrease in the efficiency of cooling the cell having a relatively small height.

The present disclosure has been made to solve the above problem. An object of the present disclosure is to provide a power storage device that can efficiently cool a plurality of power storage cells.

A power storage device according to one aspect of the present disclosure includes a power storage module, a cooler arranged above the power storage module in a vertical direction, and a thermally conductive layer sandwiched between the power storage module and the cooler. The power storage module includes a plurality of power storage cells stacked in a prescribed direction. The cooler includes a plurality of flow path portions arranged side by side in the prescribed direction and extending in a longitudinal direction of each of the plurality of power storage cells, and at least one connecting portion arranged between the plurality of flow path portions arranged side by side in the prescribed direction. The at least one connecting portion has a bending rigidity lower than that of each of the plurality of flow path portions.

In the power storage device according to one aspect of the present disclosure, as described above, the at least one connecting portion has a bending rigidity lower than that of each of the plurality of flow path portions. As a result, each of the plurality of flow path portions can be arranged while bending the at least one connecting portion. This allows each of the plurality of flow path portions to easily adhere to the thermally conductive layer by bending the at least one connecting portion without adjusting the thickness of the thermally conductive layer according to the height of the power storage cell when there are variations in height among the plurality of power storage cells. In other words, the height position of each of the plurality of flow path portions can conform to (follow) the height position of the thermally conductive layer by bending the at least one connecting portion without arranging a relatively thick thermally conductive layer on a power storage cell having a relatively small height (arranging a thermally conductive layer having a relatively small thickness on a power storage cell having a relatively large height). As a result, the thickness of the thermally conductive layer can be made uniform. This allows efficient cooling of the plurality of power storage cells.

In the power storage device according to one aspect described above, preferably, the at least one connecting portion has a projecting shape projecting upward in the vertical direction or downward in the vertical direction. With this configuration, the at least one connecting portion can have a larger length (line length) than when the at least one connecting portion has a flat shape. As a result, the bending rigidity of the at least one connecting portion described above can be reduced more easily than when the at least one connecting portion has a flat shape.

In the power storage device according to one aspect described above, preferably, the power storage module includes a thermally insulating material arranged between at least some power storage cells of the plurality of power storage cells. The thermally insulating material is arranged at a position at which the thermally insulating material overlaps the at least one connecting portion in the vertical direction. Herein, the thermally conductive layer does not need to be stacked on the thermally insulating material. Thus, as the thermally insulating material is arranged at a position at which the thermally insulating material overlaps the at least one connecting portion in the vertical direction, the at least one connecting portion can be bent at a position at which the thermally conductive layer is not arranged. This can suppress the thermally conductive layer interfering with the at least one connecting portion, allowing the at least one connecting portion to be bent more easily.

In the power storage device according to one aspect described above, preferably, the at least one connecting portion includes a plurality of connecting portions. The plurality of connecting portions are arranged with a spacing in between in the prescribed direction, the spacing corresponding to a prescribed number of power storage cells of the plurality of power storage cells. With this configuration, the connecting portion can be arranged for every prescribed number of power storage cells. This allows each of the plurality of flow path portions to follow variations in height among the power storage cells more preferably.

In this case, preferably, the prescribed number is three. With this configuration, the connecting portion can be arranged for every three power storage cells.

In the power storage device according to one aspect described above, preferably, each of the plurality of flow path portions is provided across some power storage cells of the plurality of power storage cells. Each of the plurality of flow path portions includes a first flow path through which a coolant flows from a first side in the longitudinal direction to a second side in the longitudinal direction, and a second flow path through which the coolant flows from the second side in the longitudinal direction to the first side in the longitudinal direction. With this configuration, the portion (upstream portion) of the power storage cell on the first side in the longitudinal direction can be cooled by the first flow path more effectively than the portion (downstream portion) of the power storage cell on the second side in the longitudinal direction. Also, the portion (upstream portion) of the power storage cell on the second side in the longitudinal direction can be cooled by the second flow path more effectively than the portion (downstream portion) of the power storage cell on the first side in the longitudinal direction. As a result, the temperature distribution among a plurality of power storage cells in the longitudinal direction can be made uniform by the coolant flowing through each of the first flow path and the second flow path.

In this case, preferably, the first flow path is arranged at a middle portion of each of the plurality of flow path portions in the prescribed direction. The second flow path includes a first-side flow path connected to a first branch flow path branched off from the first flow path to a first side in the prescribed direction, and a second-side flow path connected to a second branch flow path branched off from the first flow path to a second side in the prescribed direction. With this configuration, the first flow path (first-side flow path) can be a flow path upstream of the second flow path (second-side flow path), causing the temperature of the coolant flowing through the first flow path to be lower than the temperature of the coolant flowing through the second flow path. Herein, the temperature of the power storage cell arranged at the middle portion in the prescribed direction among the plurality of power storage cells tends to be higher than the temperature of the power storage cell arranged on the end side in the prescribed direction. With this configuration, thus, the power storage cell that tends to have a relatively high temperature can be cooled by the coolant having a relatively low temperature, which flows through the first flow path, and also, the power storage cell that tends to have a relatively low temperature can be cooled by the coolant having a relatively high temperature, which flows through the second flow path. This can suppress variations in temperature among the plurality of power storage cells.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an exploded perspective view showing a configuration of a power storage device according to an embodiment.

FIG. 2 is a perspective view showing a configuration of a power storage cell according to the embodiment.

FIG. 3 is a sectional view taken along the line III-III of FIG. 1.

FIG. 4 is a sectional view of a power storage module with variations in height among power storage cells.

FIG. 5 is a plan view of a cooler and a power storage module according to the embodiment, as viewed from the Z1 side.

FIG. 6 is a sectional view of a power storage module according to a first modification of the embodiment.

FIG. 7 is a sectional view of a power storage module according to a second modification of the embodiment.

FIG. 8 is a plan view showing a configuration of a flow path portion according to a third modification of the embodiment.

### DESCRIPTION OF THE PREFERRED EMBODIMENTS

Embodiments of the present disclosure will be described below in detail with reference to the drawings. The same or corresponding portions in the drawings are denoted by the same reference characters, and description thereof will not be repeated.

The vertical direction will be referred to as a Z direction herein. Specifically, the upward direction and the downward direction of the extension direction will be referred to as a Z1 direction and a Z2 direction, respectively. Each of an X direction and a Y direction is a direction (i.e., horizontal direction) orthogonal to the Z direction. The X direction is orthogonal to the Y direction. The X direction and the Y direction are examples of the “prescribed direction” and the “longitudinal direction”, respectively, in the present disclosure. The Z direction is an example of the “vertical direction” in the present disclosure.

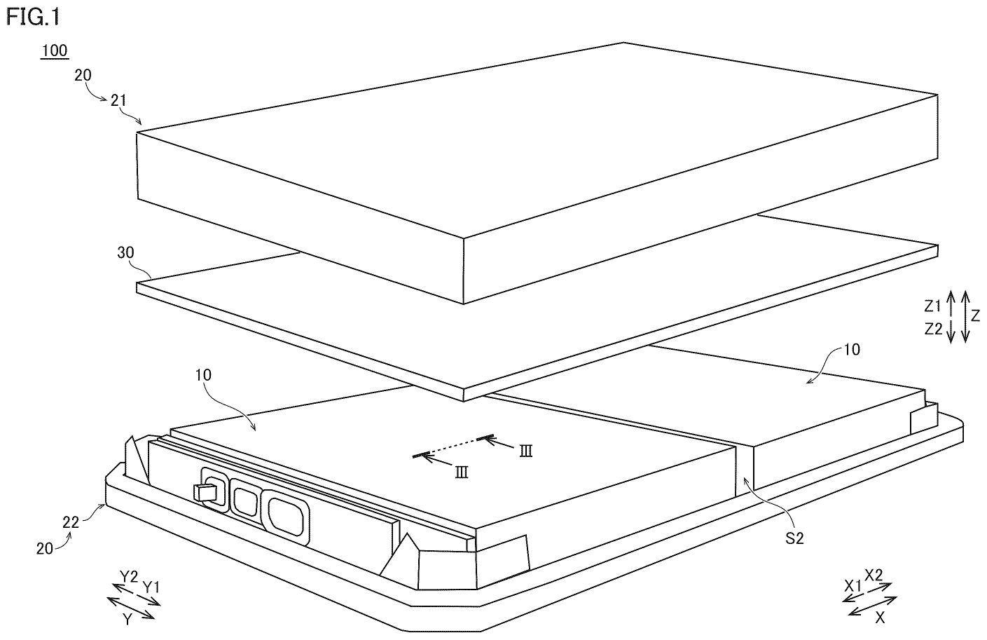

FIG. 1 is a perspective view showing a configuration of a power storage device 100 according to the present embodiment. Power storage device 100 is, for example, a device for storing electric power for driving an electrically powered vehicle (not shown). The X direction shown in FIG. 1 is, for example, the front-rear direction of the electrically powered vehicle. The Y direction is the right-left direction of the electrically powered vehicle. Power storage device 100 may be provided in an electrical device (e.g., stationary power storage device) other than the electrically powered vehicle.

Power storage device 100 includes a plurality of (two in the present embodiment) power storage modules 10, a case 20, and a cooler 30. The number of power storage modules 10 is not limited to the above example. One power storage module 10 or three or more power storage modules 10 may be provided.

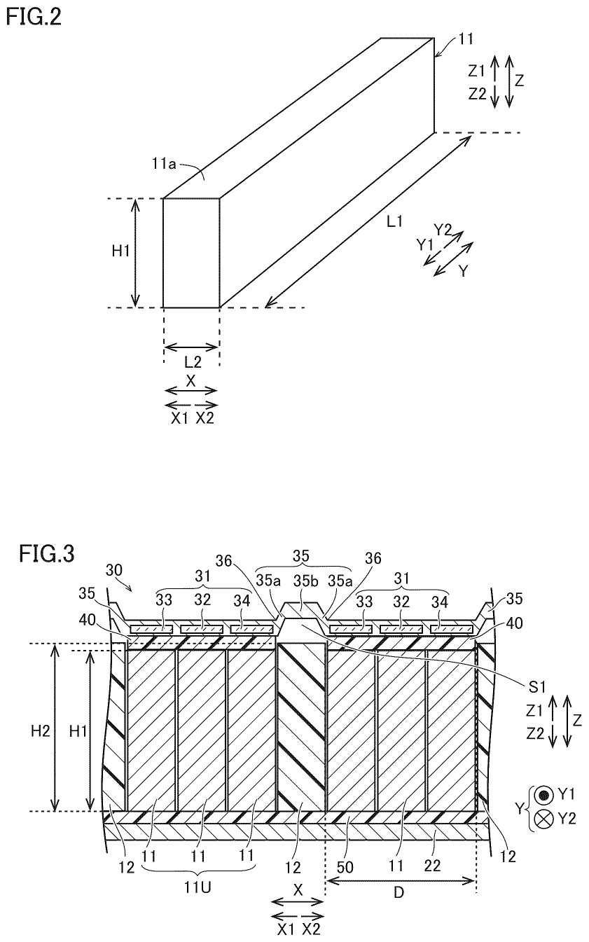

FIG. 2 is a perspective view showing a structure of one of a plurality of power storage cells 11 included in power storage module 10. Power storage cells 11 have the same structure and the same orientation. Each of power storage cells 11 is formed to extend in the Y direction. Specifically, power storage cell 11 has the shape of a prism formed to extend in the Y direction. Power storage cells 11 are stacked (arranged) in the X direction (see FIG. 3).

Power storage cell 11 has a length L1 in the Y direction. Power storage cell 11 has a length L2 in the X direction. Length L1 is greater than length L2. In other words, power storage cell 11 has the Y direction as its longitudinal direction. Power storage cell 11 also has a height H1 in the Z direction. Height H1 is smaller than length L1. Height H1 is greater than length L2. Each of power storage cells 11 may be arranged to extend in the X direction.

Referring again to FIG. 1, case 20 houses power storage modules 10. Case 20 includes an upper case 21 and a lower case 22. Power storage modules 10 are housed in the space defined by assembly of upper case 21 to lower case 22. Cooler 30 is also housed in the space described above. The configuration of case 20 is not limited to the example shown in FIG. 1. For example, upper case 21 may not be included in case 20. Cooler 30 is an example of the “cooler” in the present disclosure.

Cooler 30 is arranged above (to the Z1 side of) power storage module 10. Cooler 30 is provided to cover power storage modules 10 from the Z1 side. Cooler 30 has the shape of a plate formed to extend along the XY plane. Cooler 30 cools power storage module 10 by a coolant flowing through a flow path portion 31, which will be described later.

FIG. 3 is a sectional view taken along the line III-III of FIG. 1. As shown in FIG. 3, power storage device 100 includes a thermally conductive layer 40. Thermally conductive layer 40 is applied to an upper end surface 11a (see FIG. 2) of each of power storage cells 11. Thermally conductive layer 40 is sandwiched between cooler 30 and power storage module 10 (power storage cells 11). In other words, thermally conductive layer 40 is stacked on power storage module 10. Cooler 30 is stacked on thermally conductive layer 40. Thermally conductive layer 40 is formed of, for example, a thermally conductive adhesive material.

Power storage module 10 (see FIG. 1) also includes a thermally insulating material 12. Thermally insulating material 12 is arranged between at least some power storage cells 11 of power storage cells 11. A plurality of thermally insulating materials 12 are arranged. Specifically, thermally insulating material 12 is provided for every three power storage cells 11 (a power storage cell unit 11U, which will be described later) stacked (arranged) in the X direction. Thermally conductive layer 40 is not arranged (stacked) on thermally insulating material 12. Thermally insulating material 12 is also formed to extend in the Y direction (with the Y direction as its longitudinal direction), similarly to power storage cell 11, which is not shown in the figure.

Power storage device 100 includes an adhesive layer 50. Adhesive layer 50 is sandwiched between lower case 22 and power storage module 10. Power storage module 10 is fixed to lower case 22 by adhesive layer 50.

Cooler 30 includes a plurality of flow path portions 31 arranged side by side in the X direction. Each of flow path portions 31 is formed to extend along the Y direction. Specifically, each of flow path portions 31 includes a flow path 32, a flow path 33, and a flow path 34. Each of flow path 32, flow path 33, and flow path 34 is formed to extend along the Y direction. Flow path 32, flow path 33, and flow path 34 communicate with one another. Flow path 32 is an example of the “first flow path” in the present disclosure. Flow path 33 is an example of the “second flow path” and the “first-side flow path” in the present disclosure. Flow path 34 is an example of the “second flow path” and the “second-side flow path” in the present disclosure.

Flow path 32 is arranged at the middle portion of each of flow path portions 31. In other words, flow path 32 is arranged between flow path 33 and flow path 34. Flow path 33 is arranged on the X1 side of flow path 32. Flow path 33 is provided in the vicinity of an end of each of flow path portions 31 on the X1 side. Flow path 34 is arranged on the X2 side of flow path 32. Flow path 34 is provided in the vicinity of an end of each of flow path portions 31 on the X2 side. The X1 side and the X2 side are examples of the “first side in the prescribed direction” and the “second side in the prescribed direction”, respectively, in the present disclosure.

Cooler 30 includes a connecting portion 35 arranged between flow path portions 31 provided side by side (adjacent to each other) in the X direction. Connecting portion 35 connects flow path portions 31 to each other. Cooler 30 includes a plurality of connecting portions 35. Connecting portions 35 are formed integrally with flow path portions 31. In other words, cooler 30 is formed by processing a single plate member. The method of manufacturing cooler 30 is not limited to the example described above. For example, flow path portions 31 individually provided may be welded together by connecting portion 35. Alternatively, flow path portion 31 may be formed by laying two plates one on top of the other in the Z direction.

It is conceivable that there may be variations in height H1 among power storage cells 11. In this case, power storage cell 11 having a relatively small height H1 needs a relatively thick thermally conductive layer 40 to be arranged (stacked) thereon to conform to a conventional cooler having a flat shape. This results in a decrease in the efficiency of cooling power storage cell 11 having a relatively small height H1.

In the present embodiment, thus, each of connecting portions 35 has a bending rigidity lower than that of each of flow path portions 31. In other words, each of connecting portions 35 is deformed (bent) more easily than each of flow path portions 31. Specifically, the bending rigidity described above refers to a rigidity against bending of power storage cell 11 around the longitudinal direction (Y direction).

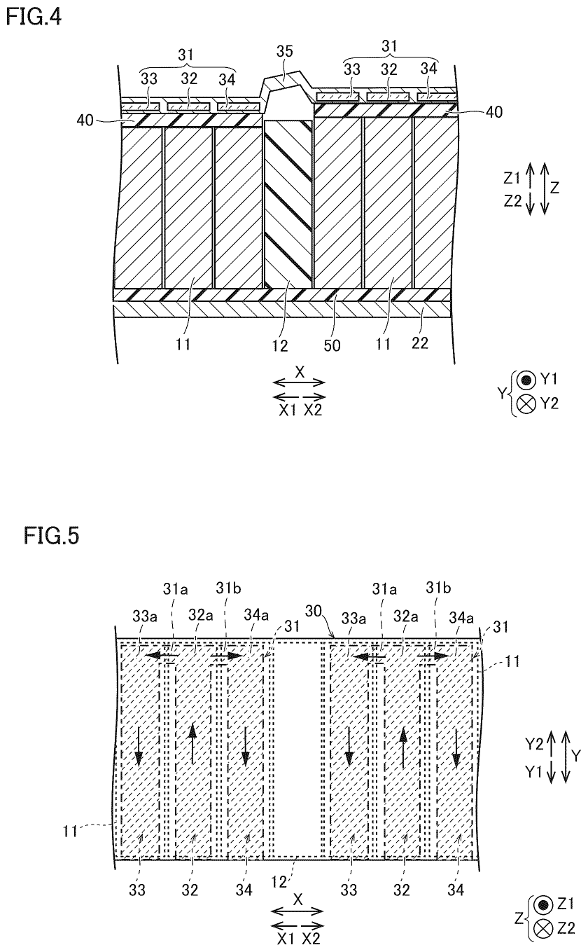

Consequently, even when there are variations in height H1 (see FIG. 3) among power storage cells 11 as shown in FIG. 4, variations in height H1 can be accommodated by bending connecting portion 35 having a relatively low bending rigidity. Specifically, cooler 30 (each flow path portion 31) can be arranged on thermally conductive layer 40 while bending connecting portion 35. This allows the height positions of flow path portions 31 on both sides of connecting portion 35 to differ from each other by bending connecting portion 35. As a result, a pressing force can be easily applied to thermally conductive layer 40, which is arranged on power storage cell 11 having a relatively small height H1, by flow path portion 31 from the Z1 side.

Referring again to FIG. 3, in the present embodiment, connecting portion 35 has a projecting shape projecting upward (to the Z1 side) in the vertical direction. Specifically, connecting portion 35 includes a pair of side portions 35a extending on the Z1 side from ends of its adjacent flow path portions 31. Connecting portion 35 also includes a flat portion 35b connecting the ends of the pair of side portions 35a on the Z1 side to each other. Flat portion 35b extends along the XY plane so as to intersect the Z direction. Connecting portions 35 have the same shape. A bent portion 36 is formed between each of the pair of side portions 35a and flow path portion 31.

Connecting portions 35 are arranged with a spacing D, which corresponds to three stacked power storage cells 11, in between in the X direction. The three power storage cells 11 constitute power storage cell unit 11U. Spacing D is approximately equal to the spacing between thermally insulating materials 12. Each of flow path portions 31 is provided across the three power storage cells 11. In other words, each of flow path portions 31 is provided to cover power storage cell unit 11U from the Z1 side. Thermally conductive layer 40 is arranged on each of power storage cell units 11U. In other words, thermally conductive layers 40 partitioned for each power storage cell unit 11U are arranged on power storage module 10.

Flow path 32 is arranged on the Z1 side of power storage cell 11 of power storage cell unit 11U which is located in the middle in the X direction. Flow path 33 is arranged on the Z1 side of power storage cell 11 of power storage cell unit 11U which is located on the X1 side. Flow path 34 is arranged on the Z1 side of power storage cell 11 of power storage cell unit 11U which is located on the X2 side.

Thus, each of three power storage cells 11 is cooled by a different flow path (32, 33, or 34). In other words, three power storage cells 11 can be cooled individually. This can suppress interference of cooling of each power storage cell 11 by another power storage cell 11, thus efficiently cooling each power storage cell 11.

Thermally insulating material 12 is arranged at a position at which thermally insulating material 12 overlaps each of connecting portions 35 in the Z direction. A space S1 is defined between thermally insulating material 12 and connecting portion 35 arranged at a position at which thermally insulating material 12 overlaps connecting portion 35 in the Z direction. Thermally conductive layer 40 is not arranged in space S1.

Thermally insulating material 12 has a height H2 in the Z direction. Height H2 is greater than height H1 of power storage cell 11.

FIG. 5 is a plan view of cooler 30 as viewed from the Z1 side. The dashed line and the alternate long and short dash line in FIG. 5 indicate power storage cell 11 and flow path portion 31, respectively. The arrows in FIG. 5 indicate the directions in which a coolant flows. In flow path 32, the coolant flows from the Y1 side to the Y2 side. In each of flow path 33 and flow path 34, the coolant flows from the Y2 side to the Y1 side. In other words, the coolant flowing through flow path 32 and the coolant flowing through each of flow path 33 and flow path 34 flow in the opposite directions. The directions in which the coolant flows in the respective flow paths (32 to 34) are the same among flow path portions 31. The Y1 side and the Y2 side are examples of the “fist side in the longitudinal direction” and the “second side in the longitudinal direction”, respectively, in the present disclosure.

Each of flow path portions 31 includes a connecting flow path 31a branched off from flow path 32 to the X1 side and a connecting flow path 31b branched off from flow path 32 to the X2 side. Connecting flow path 31a connects an end 32a of flow path 32 on the Y2 side to an end 33a of flow path 33 on the Y2 side. Connecting flow path 31b connects end 32a to an end 34a of flow path 34 on the Y2 side. Connecting flow path 31a and connecting flow path 31b are examples of the “first branch flow path” and the “second branch flow path”, respectively, in the present disclosure.

Thus, flow path 32 and flow path 33 form a U-shaped flow path. Flow path 32 and flow path 34 form a U-shaped flow path. Flow path 32, flow path 33, and flow path 34 form a W-shaped flow path.

As can be seen from dividing of the coolant as described above, the coolant flowing through flow path 32 has a flow rate greater than the flow rate of the coolant flowing through each of flow path 33 and flow path 34. For example, the flow rate of the coolant flowing through flow path 32 may be twice the flow rate of the coolant flowing through each of flow path 33 and flow path 34. The flow rate of the coolant flowing through flow path 33 may be equal to the flow rate of the coolant flowing through flow path 34. The flow path area of flow path 32 may be greater than (e.g., twice) the flow path area of each of flow path 33 and flow path 34, which is not shown in the figure.

As described above, in the present embodiment, each of connecting portions 35 has a bending rigidity lower than that of each of flow path portions 31. This enables bending of each of connecting portions 35 without bending each of flow path portions 31. This allows the height positions of flow path portions 31 connected to each other by bent connecting portion 35 to differ from each other by bending connecting portion 35. Consequently, each flow path portion 31 can be easily arranged on power storage cell 11 (thermally conductive layer 40) by bending connecting portion 35 even when there are variations in height H1 among power storage cells 11. This eliminates the need for adjusting the thickness of thermally conductive layer 40 for each power storage cell 11 to accommodate variations in height H1 among power storage cells 11. As a result, thermally conductive layer 40 can have a uniform thickness, resulting in more efficient (more uniform) cooling by cooler 30.

In the present embodiment, each of connecting portions 35 has a projecting shape projecting upward in the vertical direction. This results in a larger length (line length) of each of connecting portions 35 than when each of connecting portions 35 has a flat shape. As a result, the bending rigidity of each of connecting portions 35 can be reduced easily. The bending amount (deformation amount) of each of connecting portions 35 can be secured easily.

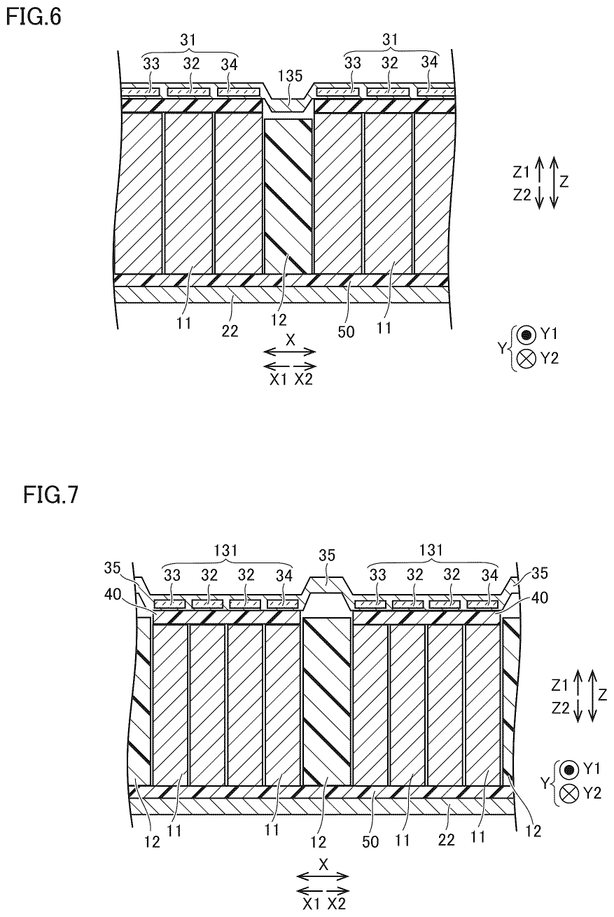

The above embodiment has described the example in which connecting portion 35 has a projecting shape projecting upward in the vertical direction, but the present disclosure is not limited thereto. As shown in FIG. 6, a connecting portion 135 projecting downward in the vertical direction may connect flow path portions 31 to each other. The above embodiment has described the example in which three power storage cells 11 are arranged in a region corresponding to spacing D between connecting portions 35, but the present disclosure is not limited thereto. Any number of, other than three, power storage cells 11 may be arranged in this region. For example, in the example shown in FIG. 7, four power storage cells 11 are arranged in this region. In this case, a flow path portion 131 may include flow path 33, flow path 34, and two flow paths 32 arranged between flow path 33 and flow path 34. Only one power storage cell 11 may be provided in this region.

The above embodiment has described the example in which the flow paths (32 to 34) in flow path portion 31 extend in the Y direction, but the present disclosure is not limited thereto. Each flow path may extend in the X direction.

The above embodiment has described the example in which a plurality of connecting portions 35 are provided in cooler 30, but the present disclosure is not limited thereto. Only one connecting portion 35 may be provided in the cooler.

The above embodiment has described the example in which power storage module 10 includes thermally insulating material 12, but the present disclosure is not limited thereto. Power storage module 10 may include no thermally insulating material 12.

The above embodiment has described the example in which connecting portion 35 is provided above thermally insulating material 12, but the present disclosure is not limited thereto. Connecting portion 35 may be provided at a position other than above thermally insulating material 12. For example, connecting portion 35 may be provided above a space S2 (see FIG. 1) between two power storage modules 10.

The above embodiment has described the example in which no flow path is provided in connecting portion 35, but the present disclosure is not limited thereto. A flow path may be provided in connecting portion 35.

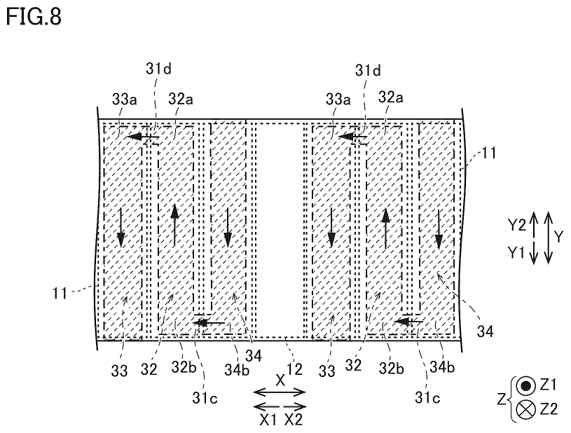

The above embodiment has described the example in which flow path 33 and flow path 34 branched off from flow path 32 are provided in flow path portion 31, but the present disclosure is not limited thereto. A place in which the coolant is divided may not be formed in the flow path portion. For example, in the example shown in FIG. 8, end 32b of flow path 32 on the Y1 side is connected to end 34b of flow path 34 on the Y1 side by connecting flow path 31c. Also, end 32a of flow path 32 is connected to end 33a of flow path 33 by connecting flow path 31d.

The above embodiment has described the example in which the number of flow paths (32 to 34) provided in flow path portion 31 is equal to the number of power storage cells 11 corresponding to flow path portion 31, but the present disclosure is not limited thereto. The number of flow paths provided in the flow path portion may be different from the number of power storage cells corresponding to the flow path portion.

The above embodiment has described the example in which each of flow path portions 31 is provided across three power storage cells 11, but the present disclosure is not limited thereto. The number of power storage cells 11 across which flow path portion 31 is provided may be different among flow path portions 31. The above embodiment has described the example in which connecting portion 35 has a projecting shape, but the present disclosure is not limited thereto. The connecting portion may be formed in a flat plate shape. For example, the bending rigidity of the connecting portion may be lower than the bending rigidity of the flow path portion due to the thickness of the connecting portion being smaller than the thickness of the flow path portion. The bending rigidity of the connecting portion may be lower than the bending rigidity of the flow path portion due to the bending rigidity of the material of the connecting portion being lower than the bending rigidity of the material of the flow path portion.

The above embodiment has described the example in which flow path 32, flow path 33, and flow path 34 communicate with one another, but the present disclosure is not limited thereto. Flow path 32, flow path 33, and flow path 34 may not communicate with one another.

The configurations (processes) of the embodiment and the modifications described above may be combined with each other.

Although the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power storage device comprising:
a power storage module;
a cooler arranged above the power storage module in a vertical direction; and
a thermally conductive layer sandwiched between the power storage module and the cooler, wherein
the power storage module includes a plurality of power storage cells stacked in a prescribed direction,
the cooler includes
a plurality of flow path portions arranged side by side in the prescribed direction and extending in a longitudinal direction of each of the plurality of power storage cells, and
at least one connecting portion arranged between the plurality of flow path portions arranged side by side in the prescribed direction, and
the at least one connecting portion has a bending rigidity lower than that of each of the plurality of flow path portions.

2. The power storage device according to claim 1, wherein the at least one connecting portion has a projecting shape projecting upward in the vertical direction or downward in the vertical direction.

3. The power storage device according to claim 1, wherein
the power storage module includes a thermally insulating material arranged between at least some power storage cells of the plurality of power storage cells, and
the thermally insulating material is arranged at a position at which the thermally insulating material overlaps the at least one connecting portion in the vertical direction.

4. The power storage device according to claim 1, wherein
the at least one connecting portion includes a plurality of connecting portions, and
the plurality of connecting portions are arranged with a spacing in between in the prescribed direction, the spacing corresponding to a prescribed number of power storage cells of the plurality of power storage cells.

5. The power storage device according to claim 4, wherein the prescribed number is three.

6. The power storage device according to claim 1, wherein
each of the plurality of flow path portions is provided across some power storage cells of the plurality of power storage cells, and
each of the plurality of flow path portions includes
a first flow path through which a coolant flows from a first side in the longitudinal direction to a second side in the longitudinal direction, and
a second flow path through which the coolant flows from the second side in the longitudinal direction to the first side in the longitudinal direction.

7. The power storage device according to claim 6, wherein
the first flow path is arranged at a middle portion of each of the plurality of flow path portions in the prescribed direction, and
the second flow path includes
a first-side flow path connected to a first branch flow path branched off from the first flow path to a first side in the prescribed direction, and
a second-side flow path connected to a second branch flow path branched off from the first flow path to a second side in the prescribed direction.
